(19) United States
(12) Patent Application Publication
(10) Pub. No.: US 2017/0278069 A1
(43) Pub. Date: Sep. 28, 2017

(54) METHOD AND ELECTRONIC DEVICE FOR EXTRACTING DATA OF NEWLY-CREATED CALENDAR EVENTS

(71) Applicants: Le Holdings (Beijing) Co., Ltd., Beijing (CN); Lemobile Information Technology (Beijing) Co., Ltd., Beijing (CN)

(72) Inventor: Yuchen Guo, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/245,009

(22) Filed: Aug. 23, 2016

Related U.S. Application Data
(63) Continuation of application No. PCT/CN2016/088775, filed on Jul. 6, 2016.

(30) Foreign Application Priority Data
Mar. 25, 2016 (CN) 201610177325.6

(51) Int. Cl. G06Q 10/10

(52) U.S. Cl. CPC G06Q 10/1093; H04L 67/12

(57) ABSTRACT

Disclosed are a method for extracting data of newly-created calendar events and an electronic device, and relates to the field of mobile terminals. The method includes: receiving information of the newly-created calendar events, the information of the newly-created calendar events including time information of the events and content information of the events; matching the time information of the events with a date in a calendar database; and marking the time information of the events in a first display region and at the same time marking the content information of the events in a second display region. Therefore, when the events are newly created in a calendar schedule, related data information for marking the newly-created events can be effectively extracted, thereby providing convenience for users and improving user experience.

### CROSS REFERENCE TO RELATED APPLICATIONS

This application is a continuation of International Application No. PCT/CN2016/088775, filed on Jul. 5, 2016, which is based upon and claims priority to Chinese Patent Application No. 201610177325.6, filed on Mar. 25, 2016, titled “Method and Device for Extracting Data of Newly-Created Calendar Events”, the entire contents of which are incorporated herein by reference.

### TECHNICAL FIELD

The application relates to the field of mobile terminals, and particularly relates to a method for extracting data of newly-created calendar events, and an electronic device.

### BACKGROUND

With the development of mobile terminal technologies, a calendar reminder function is used in mobile terminals by more and more users. One schedule event entry may specifically comprise a date, a time, a location, a topic, an appointment or conference of a participant, etc. A traditional calendar reminder function is generally to set a time and mark a to-do event, and remind the user to complete the to-do event when the time has come.

As a time management tool, calendars greatly affect everybody's life. The users can manage their calendar events by adding events, thereby bringing convenience for scheduling life and work. However, with the increase of the schedule events, many times the users cannot quickly see where their events are created or whether the created events are effective or not, and have to recheck whether the events are correct or not, which causes the defect of complicated operations, etc.; and especially when the volume of the data of the events is large, the complexity of checking the data of the events may be increased, and even the events cannot be searched within a short period of time, which seriously affects user experience.

How to realize effective extraction of data of events newly-created in the calendar becomes a problem to be solved.

### SUMMARY

The application provides a method for extracting data of newly-created calendar events, so that related data information for marking the newly-created events can be effectively extracted, thereby improving user experience.

One objective of the embodiments of the application is to provide a method for extracting data of newly-created calendar events, comprising the steps of:

receiving information of the newly-created calendar events, the information of the newly-created calendar events including time information of the events and content information of the events; matching the time information of the events with a date in a calendar database; and marking the time information of the events in a first display region and at the same time marking the content information of the events in a second display region.

Preferably, the content information of the events comprises: data identification information of the events in a calendar and keyword information of the events, wherein the data identification information is used for identifying storage locations of the data of the calendar events in the calendar database; and after receiving the information of the newly-created calendar events, the method further comprises presenting the keyword information in the second display region according to the time information of the events and the identification information.

Preferably, after marking the keyword information in the second display region, the method further comprises acquiring a trigger action signal for representing confirmation of the newly-created calendar events; eliminating a mark of a target date corresponding to the newly-created calendar events according to the trigger action signal; and eliminating marks of the keyword information corresponding to the newly-created calendar events according to the trigger action signal.

Preferably, the method further comprises presenting the keyword information of the newly-created calendar events in a third display region after eliminating the marks of the keyword information corresponding to the newly-created calendar events.

Preferably, there are plural newly-created calendar events; and the presenting the keyword information in the third display region according to the target time information and the identification information comprises: presenting the keyword information of the plural newly-created calendar events according to the order of target times of the plural newly-created calendar events; and displaying the third display region behind the second display region.

Preferably, the second display region is a hidden region; and after acquiring the information of the newly-created calendar events, the method further comprises generating an entry for the second display region so as to enter the second display region in response to a trigger action.

Another objective of the embodiments of the application is to provide an electronic device, comprising: at least one processor; and a memory communicably connected with the at least one processor for storing instructions executable by the at least one processor, wherein execution of the instructions by the at least one processor causes the at least one processor to: receive information of the newly-created calendar events, the information of the newly-created calendar events including time information of the events and content information of the events; match the time information of the events with a date in a calendar database; and mark the time information of the events in a first display region and at the same time mark the content information of the events in a second display region.

The electronic device, wherein, the content information of the events comprises: data identification information of the events in a calendar and keyword information of the events, wherein the data identification information is used for identifying storage locations of the data of the calendar events in the calendar database; and after receiving the information of the newly-created calendar events, the keyword information is presented in the second display region according to the time information of the events and the identification information.

The electronic device, wherein, after marking of the keyword information in the second display region, a trigger action signal for representing confirmation of the newly-created calendar events is acquired; a mark of a target date corresponding to the newly-created calendar events is eliminated according to the trigger action signal; and marks of the keyword information corresponding to the newly-created calendar events are eliminated according to the trigger action signal.

The electronic device, wherein, the keyword information of the newly-created calendar events is presented in a third display region after elimination of the marks of the keyword information corresponding to the newly-created calendar events.

The electronic device, wherein, there are plural newly-created calendar events; and the presenting the keyword information in the third display region according to the target time information and the identification information comprises: presenting the keyword information of the plural newly-created calendar events according to the order of target times of the plural newly-created calendar events; and displaying the third display region behind the second display region.

The electronic device, wherein, the second display region is a hidden region; and after acquisition of the information of the newly-created calendar events, an entry for the second display region is generated for entrance to the second display region in response to a trigger action.

A further objective of the embodiments of the application is to provide a non-transitory computer-readable storage medium storing executable instructions that, when executed by an electronic device, cause the electronic device to: receive information of the newly-created calendar events, the information of the newly-created calendar events including time information of the events and content information of the events; match the time information of the events with a date in a calendar database; and mark the time information of the events in a first display region and at the same time mark the content information of the events in a second display region.

The non-transitory computer-readable storage medium, wherein, the content information of the events comprises: data identification information of the events in a calendar and keyword information of the events, wherein the data identification information is used for identifying storage locations of the data of the calendar events in the calendar database; and after receiving of the information of the newly-created calendar events, the keyword information is presented in the second display region according to the time information of the events and the identification information.

The non-transitory computer-readable storage medium, wherein, after marking of the keyword information in the second display region, a trigger action signal for representing confirmation of the newly-created calendar events is acquired; a mark of a target date corresponding to the newly-created calendar events is eliminated according to the trigger action signal; and marks of the keyword information corresponding to the newly-created calendar events are eliminated according to the trigger action signal.

The non-transitory computer-readable storage medium, wherein, the keyword information of the newly-created calendar events is presented in a third display region after elimination of the marks of the keyword information corresponding to the newly-created calendar events.

The non-transitory computer-readable storage medium, wherein, there are plural newly-created calendar events; and the presenting the keyword information in the third display region according to the target time information and the identification information comprises: presenting the keyword information of the plural newly-created calendar events according to the order of target times of the plural newly-created calendar events; and displaying the third display region behind the second display region.

The non-transitory computer-readable storage medium, wherein, the second display region is a hidden region; and after acquisition of the information of the newly-created calendar events, an entry for the second display region is generated for entrance to the second display region in response to a trigger action.

In the method and electronic device for extracting data of the newly-created calendar events provided in the embodiments of the application, received information of the newly-created calendar events comprises time information of the events and content information of the events, the time information of the events is matched with a date in a calendar database, and then the time information of the events is marked in a first display region and at the same time the content information of the events is marked in a second display region, so that when the events are newly-created in a calendar schedule, related data information for marking the newly-created events can be effectively extracted, thereby providing convenience for users and improving user experience.

As a preferred technical solution, after the information of the newly-created calendar events is acquired, keyword information is presented and marked in the second display region so that the keyword information of the newly-created events is more effectively extracted.

As a preferred technical solution, the keyword information of plural newly-created calendar events is presented according to the order of target times of the plural newly-created calendar events; and a third display region is displayed behind the second display region. Thus, when there are too many calendar events, the keyword information of the newly-created calendar events is prior to the keyword information of historical calendar events, thereby facilitating extraction of the keyword information of the newly-created calendar events from the display regions.

As a preferred technical solution, the second display region is a hidden region, thereby saving display space; and an entry for the second display region is generated for entrance to the second display region in response to a trigger action, thereby providing convenience for entering the second display region under excitation of the trigger action and facilitating quick extraction of the keyword information of the newly-created calendar events.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for extracting data of newly-created calendar events disclosed in the embodiments of the application;

FIG. 2 is a schematic diagram of a calendar interface disclosed in the embodiments of the application;

FIG. 3 is a schematic diagram of distribution of a second display region and a third display region in the embodiments of the application;

FIG. 4 is a schematic diagram of a device for extracting data of newly-created calendar events disclosed in the embodiments of the application;

FIG. 5 is a schematic diagram of hardware configuration of an electronic device performing the method for extracting data of newly-created calendar events provided by the embodiment of the application.

### DETAILED DESCRIPTION

In order to clearly describe objectives, the technical solutions and advantages of the application. A clear and complete description of the technical solutions in the application will be given below, in conjunction with the accompanying drawings in the embodiments of the application. Apparently, the embodiments described below are a part, but not all, of the embodiments of the application.

### Embodiment 1

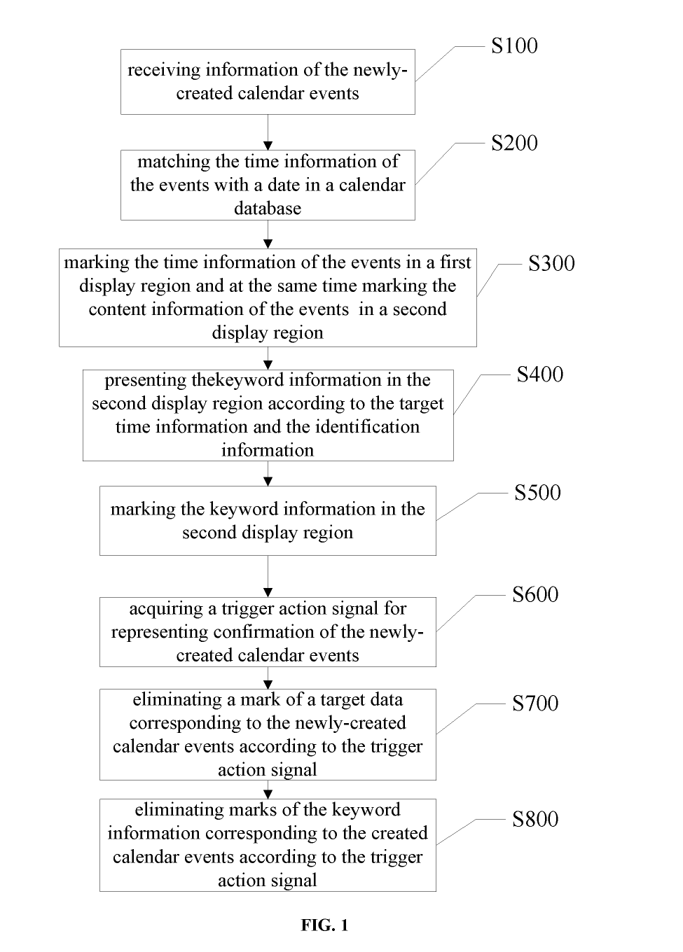

In order to realize effective extraction of data of events newly-created in a calendar schedule, the embodiments of the application disclose a method for extracting data of newly-created calendar events. Refer to FIG. 1, which shows a flow chart of the method. The method for extracting data of the newly-created calendar events comprises the following steps:

step S100, receiving information of the newly-created calendar events; wherein, in the embodiment, the information of the newly-created calendar events includes time information of the events and content information of the events; generally, after application software of the calendar schedule is loaded in a mobile terminal, a user can create a to-do event memorandum at any target date or target date and time of the calendar; specifically, the input of the newly-created calendar events can be achieved by means of input devices (such as keyboards, touch screens, etc.) with which the mobile terminal is equipped so that the to-do events are created; in a specific embodiment, the information of the newly-created calendar events are required to be received and the information of the newly-created calendar events should include the time information of the events and the content information of the events; in the embodiment, the time information of the events may be a date of the events, or a certain specific time of a certain day, or a certain period of time; and specifically, the information of the target time may be manually inputted or selected from a calendar display interface by the user;

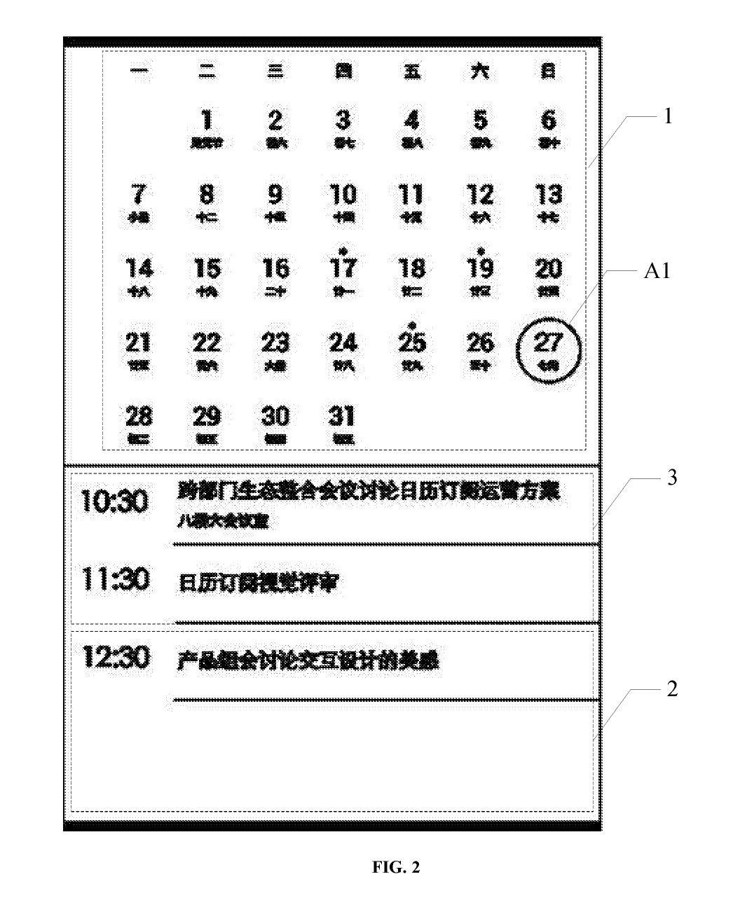

step S200, matching the time information of the events with a date in a calendar database; wherein, refer to FIG. 2, which shows a schematic diagram of a calendar interface; the calendar is visually displayed in a first display region 1 by means of the calendar database, and the calendar database may contain solar calendar information and/or lunar calendar information; in the embodiment, taking a solar calendar as an example, a target date A1 in the calendar database is searched according to the acquired time information of the newly-created calendar events; for example, the target date A1 is “27th, May”, namely the newly-created calendar events are set on “27th, May” and are to-do items on 27th, May; and it should be noted that in the above embodiment and subsequent embodiments, the value of the target date A1 is merely an example, and should not be understood as a limitation to the technical solution of the embodiment; and

step S300, marking the time information of the events in a first display region and at the same time marking the content information of the events in a second display region; wherein after the time information of the events is matched with the date in the calendar database, the time information of the events can be marked on the target date A1 of the calendar interface in the first display region 1; in a specific embodiment, the way of marking should be capable of emphasizing the target date A1, for example, the way of marking may be font marking or style marking such as bold fonts, italic, etc. or may be a way of adding partial or full borders; in a preferred embodiment, the marking is performed in a way of highlighting the target date A1, so that it is realized that related data information for marking the newly-created events can be effectively extracted when the events are newly-created in the calendar schedule, thereby providing convenience for users and improving user experience; in a specific embodiment, refer to FIG. 2, the content information of the events can be marked in the second display region 2 at the same time that the time information of the events is marked in the first display region; it should be noted that the “at the same time” in the embodiment does not require entire equation in time, and allows existence of a certain order; and in a preferred embodiment, the content information of the events comprises: data identification information of the newly-created calendar events in the calendar and keyword information of the events, wherein the data identification information is used for identifying storage locations of the data of the calendar events in the calendar database and the keyword information may be label information, such as title of the newly-created calendar events, etc., which can represent the newly-created calendar events. After step S100 is executed, refer to FIG. 1, the method for extracting data of the newly-created calendar events further comprises the following steps:

step S400, presenting the keyword information in the second display region according to the target time information and the identification information; wherein, refer to FIG. 2, after the target time information and the identification information are acquired, the data of the newly-created calendar events can be searched in the calendar database according to the identification information, and the keyword information of the newly-created calendar events is presented in the second display region 2; in a specific embodiment, the data of the newly-created calendar events can be mapped to the identification information and the keyword information; after the keyword information of the events presented in the second display region 2 is triggered, the data of the newly-created calendar events in the calendar database is extracted through an index of the mapped identification information.

Refer to FIG. 2; in a preferred embodiment, the method may further comprise:

step S500, marking the keyword information in the second display region; wherein the way of marking should be capable of emphasizing the keyword information of the newly-created calendar events, for example, the way of marking may be font marking or style marking such as fold fonts, italic, etc. or may be a way of adding partial or full borders; in a preferred embodiment, the marking is performed in a way of highlighting the keyword information of the newly-created calendar events, so that it is realized that related data information for marking the newly-created events can be effectively extracted when the events are newly-created in the calendar schedule, thereby providing convenience for users and improving user experience.

It should be noted that the execution order between step S200 and step S400 is not limited in the embodiment.

In a preferred embodiment, refer to the drawings, after step S500 is executed, the method further comprises:

step S600, acquiring a trigger action signal for representing confirmation of the newly-created calendar event; wherein generally, after calendar events are created, the user needs to check and verify the newly-created calendar events, e.g., whether the calendar events are created on a correct date or not, whether correct items are inputted or not, etc.; in the embodiment, the trigger action signal for representing confirmation of the newly-created calendar events is acquired, and the newly-created calendar events are extracted according to the trigger action signal to be checked by the user; in a specific embodiment, the way of triggering confirmation of the newly-created calendar events may be triggering the target date A1 marked in the first display region 1 or the keyword information marked in the second display region 2; and it should be noted that the extracted newly-created calendar events should be the newly-created calendar events mapped to the triggered target date A1 or the keyword information when the newly-created calendar events are extracted according to the trigger action signal;

step S700, eliminating a mark of a target date corresponding to the newly-created calendar events according to the trigger action signal; wherein after the trigger action signal is acquired, information that the user has confirmed the newly-created calendar events is represented, so that the mark of the target date Al mapped to the newly-created calendar events in the first display region 1 can be eliminated according to the trigger action signal; and it should be noted that whether the information (such as target time, event content, etc.) of the newly-created calendar events is correct or not is not taken as a limitation to the elimination of the mark when the mark of the target date corresponding to the newly-created calendar events is eliminated according to the trigger action signal; and

step S800, eliminating marks of the keyword information corresponding to the newly-created calendar events according to the trigger action signal; wherein after the trigger action signal is acquired, information that the user has confirmed the newly-created calendar events is represented, so that the marks of the keyword information mapped to the newly-created calendar events in the second display region 2 can be eliminated according to the trigger action signal; and it should be noted that whether the information (such as target time, event content, etc.) of the newly-created calendar events is correct or not is not taken as a limitation to the elimination of the marks when the marks of the keyword information corresponding to the newly-created calendar events is eliminated according to the trigger action signal. It should be noted that the execution order between step S700 and step S800 is not limited in the embodiment.

In a preferred embodiment, after step S800 is executed, refer to FIG. 2, the keyword information of the newly-created calendar events can also be presented in a third display region 3 after the marks of the keyword information corresponding to the newly-created calendar events is eliminated; specifically, the keyword information presented in the third display region 3 is the calendar events confirmed by a trigger action signal; and in a specific embodiment, the keyword information can be successively arranged in the third display region 3 according to the order of the target times of the events.

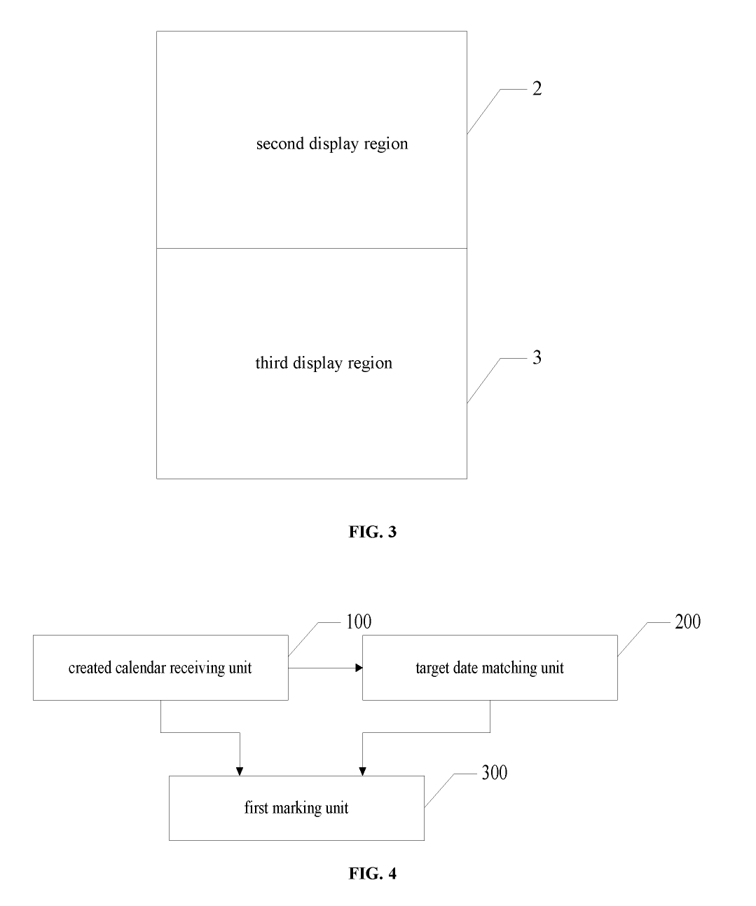

In a preferred embodiment, when there are plural newly-created calendar events, step S400 is executed as follows: the keyword information of the plural newly-created calendar events is presented according to the order of target times of the plural newly-created calendar events, and specifically, the keyword information is successively arranged in the second display region 2 according to the order of the target times of the events. In order to present the newly-created calendar events which are not confirmed by the user in prior, refer to FIG. 3, the third display region 3 can be displayed behind the second display region 2; and specifically, based on the rule of from top to bottom or from left to right, the third display region 3 is displayed below the second display region 2, or the third display region 3 is displayed at the right of the second display region 2, thereby facilitating acquisition of the trigger action signal in the second display region 2 and facilitating extraction of the data of the newly-created calendar events.

In order to save the area of the display regions, in a preferred embodiment, the second display region 2 may be a hidden region; and after the information of the newly-created calendar events is acquired, an entry for the second display region 2 can also be generated and is used for entering the second display region 2 in response to a trigger action. In a specific embodiment, the generated entry for the second display region 2 can be arranged in any location of the display region having a touch function or on a physical button of the mobile terminal For a mobile terminal having the touch function, the generated entry of the second display region 2 can be preferably arranged in a functional region of the mobile terminal

### Embodiment 2

The embodiments of the application provide a device for extracting data of newly-created calendar events, refer to FIG. 2, comprising a newly-created calendar receiving unit 100, a target date matching unit 200 and a first marking unit 300, wherein:

The newly-created calendar receiving unit 100 receives information of the newly-created calendar events, the information of the newly-created calendar events including time information of the events and content information of the events; the target date matching unit 200 matches the time information of the events with a date in a calendar database; and a first marking unit 300 marks the time information of the events in a first display region and at the same time marking the content information of the events in a second display region.

As a preferred embodiment, the device for extracting data of the newly-created calendar events further comprises a keyword presenting unit that presents the keyword information in the second display region according to the time information of the events and the identification information

As a preferred embodiment, the device for extracting data of the newly-created calendar events further comprises a trigger action acquiring unit that acquires a trigger action signal for representing confirmation of the newly-created calendar events; a first eliminating unit that eliminates a mark of a target date corresponding to the newly-created calendar events according to the trigger action signal; and a second eliminating unit that eliminates marks of the keyword information corresponding to the newly-created calendar events according to the trigger action signal.

As a preferred technical solution, the second display region is a hidden region, and the extracting device also comprises an entry for the second display region is generated so as to enter the second display region in response to a trigger action.

In the device for extracting data of the newly-created calendar events provided in the embodiments of the application, received information of the newly-created calendar events comprises time information of the events and content information of the events, the time information of the events is matched with a date in a calendar database, and then the time information of the events is marked in a first display region and at the same time the content information of the events is marked in a second display region, so that when the events are newly-created in a calendar schedule, related data information for marking the newly-created events can be effectively extracted, thereby providing convenience for users and improving user experience.

As a preferred embodiment, the keyword information is presented and marked in the second display region after the information of the newly-created calendar events is acquired, so that the keywords information of the newly-created events can be extracted more effectively.

As a preferred embodiment, the keyword information of plural newly-created calendar events is presented according to the order of target times of the plural newly-created calendar events; and a third display region is displayed behind the second display region. Thus, when there are too many calendar events, the keyword information of the newly-created calendar events is prior to the keyword information of historical calendar events, thereby facilitating extraction of the keyword information of the newly-created calendar events from the display regions.

As a preferred embodiment, the second display region is a hidden region, thereby saving display space; and an entry for the second display region is generated so as to enter the second display region in response to a trigger action, thereby providing convenience for entering the second display region under excitation of the trigger action and facilitating quick extraction of the keyword information of the newly-created calendar events.

### Embodiment 3

The embodiments of the application also provide a non-transitory computer-readable storage medium storing executable instructions that, when executed by an electronic device, cause the electronic device to: receive information of the newly-created calendar events, the information of the newly-created calendar events including time information of the events and content information of the events; match the time information of the events with a date in a calendar database; and mark the time information of the events in a first display region and at the same time mark the content information of the events in a second display region.

The non-transitory computer-readable storage medium, preferably, the content information of the events comprises: data identification information of the events in a calendar and keyword information of the events, wherein the data identification information is used for identifying storage locations of the data of the calendar events in the calendar database; and after receiving the information of the newly-created calendar events, the keyword information is presented in the second display region according to the time information of the events and the identification information.

The non-transitory computer-readable storage medium, preferably, after marking of the keyword information in the second display region, a trigger action signal for representing confirmation of the newly-created calendar events is acquired; a mark of a target date corresponding to the newly-created calendar events is eliminated according to the trigger action signal; and marks of the keyword information corresponding to the newly-created calendar events are eliminated according to the trigger action signal.

The non-transitory computer-readable storage medium, preferably, the keyword information of the newly-created calendar events is presented in a third display region after elimination of the marks of the keyword information corresponding to the newly-created calendar events.

The non-transitory computer-readable storage medium, preferably, there are plural newly-created calendar events; and the presenting the keyword information in the third display region according to the target time information and the identification information comprises: presenting the keyword information of the plural newly-created calendar events according to the order of target times of the plural newly-created calendar events; and displaying the third display region behind the second display region.

The non-transitory computer-readable storage medium, preferably, the second display region is a hidden region; and after acquisition of the information of the newly-created calendar events, an entry for the second display region is generated for entrance to the second display region in response to a trigger action.

### Embodiment 4

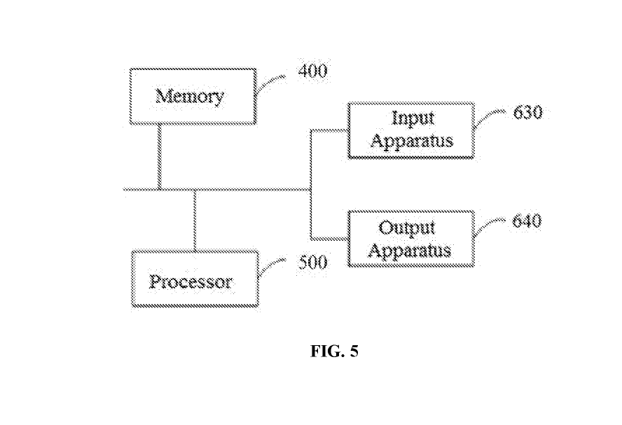

FIG. 5 is a schematic diagram of hardware configuration of an electronic device provided by the embodiment of the application, which performs the method for extracting data of the newly-created calendar events. As shown in FIG. 5, the electronic device includes: one or more processors 500 and a memory 400, wherein one processor 500 is shown in FIG. 5 as an example. The electronic device that performs the method for extracting data of the newly-created calendar events further includes an input apparatus 630 and an output apparatus 640.

The processor 500, the memory 400, the input apparatus 630 and the output apparatus 640 may be connected via a bus line or other means, wherein connection via a bus line is shown in FIG. 5 as an example.

The memory 400 is a non-transitory computer-readable storage medium that can be used to store non-transitory software programs, non-transitory computer-executable programs and modules, such as the program instructions/modules corresponding to the method for extracting data of the newly-created calendar events of the embodiments of the application (e.g. created calendar receiving unit 100, target date matching unit 200 and first marking unit 300 shown in the FIG. 4). The processor 500 executes the non-transitory software programs, instructions and modules stored in the memory 400 so as to perform various function application and data processing of the server, thereby implementing the method for extracting data of the newly-created calendar event of the above-mentioned method embodiments

The memory 400 includes a program storage area and a data storage area, wherein, the program storage area can store an operation system and application programs required for at least one function; the data storage area can store data generated by use of the device for extracting data of the newly-created calendar event. Furthermore, the memory 400 may include a high-speed random access memory, and may also include a non-volatile memory, e.g. at least one magnetic disk memory unit, flash memory unit, or other non-volatile solid-state memory unit. In some embodiments, optionally, the memory 400 includes a remote memory accessed by the processor 500, and the remote memory is connected to the device for extracting data of the newly-created calendar event via network connection. Examples of the aforementioned network include but not limited to internet, intranet, LAN, GSM, and their combinations.

The input apparatus 630 receives digit or character information, so as to generate signal input related to the user configuration and function control of the device for extracting data of the newly-created calendar event. The output apparatus 640 includes display devices such as a display screen.

The one or more modules are stored in the memory 400 and, when executed by the one or more processors 500, perform device for extracting data of the newly-created calendar event of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

What is claimed is:

1. A method for extracting data of newly-created calendar events, comprising the following steps:
receiving information of the newly-created calendar events, the information of the newly-created calendar events including time information of the events and content information of the events;
matching the time information of the events with a date in a calendar database; and
marking the time information of the events in a first display region and at the same time marking the content information of the events in a second display region.

2. The method for extracting data of the newly-created calendar events of claim 1, wherein, the content information of the events comprises: data identification information of the events in a calendar and keyword information of the events, wherein the data identification information is used for identifying storage locations of the data of the calendar events in the calendar database; and
after receiving the information of the newly-created calendar events, the method further comprises:
presenting the keyword information in the second display region according to the time information of the events and the identification information.

3. The method for extracting data of the newly-created calendar events of claim 2, wherein, after marking the keyword information in the second display region, further comprising:
acquiring a trigger action signal for representing confirmation of the newly-created calendar events;
eliminating a mark of a target date corresponding to the newly-created calendar events according to the trigger action signal; and
eliminating marks of the keyword information corresponding to the newly-created calendar events according to the trigger action signal.

4. The method for extracting data of the newly-created calendar events of claim 3, wherein, further comprising:
presenting the keyword information of the newly-created calendar events in a third display region after eliminating the marks of the keyword information corresponding to the newly-created calendar events.

5. The method for extracting data of the newly-created calendar events of claim 4, wherein, there are plural newly-created calendar events; and
the presenting the keyword information in the third display region according to the target time information and the identification information comprises:
presenting the keyword information of the plural newly-created calendar events according to the order of target times of the plural newly-created calendar events; and
displaying the third display region behind the second display region.

6. The method for extracting data of the newly-created calendar events of claim 2, wherein, the second display region is a hidden region; and after acquiring the information of the newly-created calendar events, the method further comprises:
generating an entry for the second display region so as to enter the second display region in response to a trigger action.

7. An electronic device, comprising:
at least one processor; and
a memory communicably connected with the at least one processor;
wherein, the memory stores instructions executable by the at least one processor, and execution of the instructions by the at least one processor causes the at least one processor to:
receive information of the newly-created calendar events, the information of the newly-created calendar events including time information of the events and content information of the events;
match the time information of the events with a date in a calendar database; and
mark the time information of the events in a first display region and at the same time mark the content information of the events in a second display region.

8. The electronic device of claim 7, wherein, the content information of the events comprises: data identification information of the events in a calendar and keyword information of the events, wherein the data identification information is used for identifying storage locations of the data of the calendar events in the calendar database; and after receiving of the information of the newly-created calendar events, the keyword information is presented in the second display region according to the time information of the events and the identification information.

9. The electronic device of claim 8, wherein, after marking of the keyword information in the second display region, a trigger action signal for representing confirmation of the newly-created calendar events is acquired; a mark of a target date corresponding to the newly-created calendar events is eliminated according to the trigger action signal; and marks of the keyword information corresponding to the newly-created calendar events are eliminated according to the trigger action signal.

10. The electronic device of the claim 9, wherein, the keyword information of the newly-created calendar events is presented in a third display region after elimination of the marks of the keyword information corresponding to the newly-created calendar events.

11. The electronic device of the claim 10, wherein, there are plural newly-created calendar events; and the presenting the keyword information in the third display region according to the target time information and the identification information comprises: presenting the keyword information of the plural newly-created calendar events according to the order of target times of the plural newly-created calendar events; and displaying the third display region behind the second display region.

12. The electronic device of the claim 8, wherein, the second display region is a hidden region; and after acquisition of the information of the newly-created calendar events, an entry for the second display region is generated for entrance to the second display region in response to a trigger action.

13. A non-transitory computer-readable storage medium storing executable instructions that, when executed by an electronic device, cause the electronic device to:
receive information of the newly-created calendar events, the information of the newly-created calendar events including time information of the events and content information of the events;
match the time information of the events with a date in a calendar database; and
mark the time information of the events in a first display region and at the same time mark the content information of the events in a second display region.

14. The non-transitory computer-readable storage medium of the claim 13, wherein, the content information of the events comprises: data identification information of the events in a calendar and keyword information of the events, wherein the data identification information is used for identifying storage locations of the data of the calendar events in the calendar database; and after receiving of the information of the newly-created calendar events, the keyword information is presented in the second display region according to the time information of the events and the identification information.

15. The non-transitory computer-readable storage medium of the claim 14, wherein, after marking of the keyword information in the second display region, a trigger action signal for representing confirmation of the newly-created calendar events is acquired; a mark of a target date corresponding to the newly-created calendar events is eliminated according to the trigger action signal; and marks of the keyword information corresponding to the newly-created calendar events are eliminated according to the trigger action signal.

16. The non-transitory computer-readable storage medium of the claim 15, wherein, the keyword information of the newly-created calendar events is presented in a third display region after elimination of the marks of the keyword information corresponding to the newly-created calendar events.

17. The non-transitory computer-readable storage medium of the claim 16, wherein, there are plural newly-created calendar events; and the presenting the keyword information in the third display region according to the target time information and the identification information comprises: presenting the keyword information of the plural newly-created calendar events according to the order of target times of the plural newly-created calendar events; and displaying the third display region behind the second display region.

18. The non-transitory computer-readable storage medium of the claim 14, wherein, the second display region is a hidden region; and after acquisition of the information of the newly-created calendar events, an entry for the second display region is generated for entrance to the second display region in response to a trigger action.
